(19) United States
(12) Patent Application Publication
(10) Pub. No.: US 2006/0237295 A1
(43) Pub. Date: Oct. 26, 2006

(54) Sealed soft switch assemblies

(75) Inventor: Ronal Charles Du Pont, Oakville (CA)

Correspondence Address: Tyco Technology Resources, 4550 New Linden Road, Wilmington, DE, 19808-2952, US

(73) Assignee: Tyco Electronics Canada Ltd.

(21) Appl. No.: 11/112,889

(22) Filed: Apr. 22, 2005

(51) Int. Cl. H01H 5/18

(52) U.S. Cl. 200/406

(57) ABSTRACT

A switch assembly is provided which includes a holder defining at least a pair of eyelets extending completely therethrough; an electrically conductive lead-frame supported on the holder, the lead-frame defining at least a pair of openings therein; and at least a pair of electrically conductive rivets each configured and adapted for at least partial positioning in a respective eyelet. The first opening of the lead-frame is larger than a head portion of a first rivet such that the head portion does not contact the lead-frame. The second opening of the lead-frame is smaller than a head portion of another rivet such that the head portion contacts the lead-frame. The switch assembly further includes at least one electrically conductive snap dome in electrical contact with the lead-frame and overlying the first rivet.

### BACKGROUND

1. Technical Field

The present disclosure relates to electrical switches and, more particularly, to sealed soft switch assemblies including snap domes and the like.

2. Background of Related Art

A wide variety of instruments and equipment exist which incorporate switches and the like which provide tactile and/or audible feedback, such as, for example, a feedback membrane switch or snap dome switch. Typically, the electrical contacts of such switches include an electrically conductive film disposed on an electrically insulative substrate (e.g., a printed circuit board). The electrically conductive film defines the outer contact for the outer legs of the snap dome and the center contact for the center of the snap dome.

Typically, the placement of snap domes, and the necessary spacers and membranes on a printed circuit board, is a tedious process. Additionally, space limitations in switches including printed circuit boards reduces the ability to use larger snap domes in the switch and the ability to create switches with improved tactile feedback.

Accordingly, the need exists for switches and assemblies which reduce the labor costs associated with the production thereof.

A need exists for switches and assemblies which exhibit improved tactile feedback characteristics.

A need exists for tactile feedback switches and assemblies which do not use a printed circuit board.

### SUMMARY

The present disclosure relates to sealed soft switch assemblies including snap domes and the like.

According to an aspect of the present disclosure, a sealed soft switch assembly is provided. The switch assembly includes a holder defining at least a pair of eyelets extending completely therethrough; an electrically conductive lead-frame supported on the holder, the lead-frame defining at least a pair of openings therein, each opening being aligned with a respective eyelet formed in the holder; and at least a pair of electrically conductive rivets each configured and adapted for at least partial positioning in a respective eyelet, each rivet including a stem portion and a head portion. The first opening of the lead-frame is larger than the head portion of a first rivet such that the head portion of the first rivet does not contact the lead-frame, and the second opening of the lead-frame is smaller than the head portion of another rivet such that the head portion of the other rivet contacts the lead-frame. The switch assembly further includes at least one electrically conductive snap dome in electrical contact with the lead-frame and overlying the first rivet. In use, depressing the snap dome completes an electrical circuit between the first rivet and the second rivet through the lead-frame, and releasing the snap dome disconnects the electrical circuit.

The switch assembly further includes a flexible non-conductive cover configured and dimensioned to overlie at least the first snap dome. The switch assembly may further include an overmold configured and dimensioned to encase at least the holder, the lead-frame, the rivets, the snap dome, and the cover.

Desirably, an electrical wire is connectable to each of the rivets.

In an embodiment, the holder includes a recess formed in an upper surface thereof. The recess is configured and dimensioned to receive at least the lead-frame, the rivets and the snap dome therein. It is envisioned that a first opening of the lead-frame is larger than a second opening of the lead-frame.

In another embodiment, the holder defines at least three eyelets formed therein and extending completely therethrough. The lead-frame defines at least three openings therein, wherein the three openings are in registration with the three eyelets of the holder when the lead-frame is operatively connected to the holder. A first and a second opening of the lead-frame are each larger than a third opening of the lead-frame.

The switch assembly may further include at least three electrically conductive rivets each configured and adapted for at least partial positioning in a respective eyelet of the holder. Each rivet includes a stem portion and a head portion. A first opening and a second opening in the lead-frame are each larger than the head portion of a first and a second rivet such that the head portion of each first and second rivet does not contact the lead-frame. A third opening of the lead-frame is smaller than the head portion of a third rivet such that the head portion of the third rivet contacts the lead-frame.

The switch assembly may further include a pair of snap domes, wherein a first snap dome is in electrical contact with the lead-frame and overlies the first rivet, and wherein a second snap dome is in electrical contact with the lead-frame and overlies the second rivet. In use, depressing the first snap dome completes a first electrical circuit between the first rivet and the third rivet through the lead-frame and releasing the first snap dome disconnects the first electrical circuit. Additionally, in use, depressing the second snap dome completes a second electrical circuit between the second rivet and the third rivet through the lead-frame and releasing the second snap dome disconnects the second electrical circuit.

The switch assembly may further include a flexible non-conductive cover configured and dimensioned to overlie at least the first and second snap domes. The switch assembly may further include an overmold configured and dimensioned to encase at least the holder, the lead-frame, the rivets, the snap domes, and the cover. An electrical wire may be connected to each rivet. It is envisioned that the holder may include a recess formed in an upper surface thereof, wherein the recess is configured and dimensioned to receive at least the lead-frame, the rivets, and the snap domes therein.

According to another aspect of the present disclosure, a switch assembly connectable to electrical terminals of electrical wire leads is provided. The switch assembly includes a holder defining at least three eyelets formed therein and extending completely therethrough; an electrically conductive lead-frame supported on the holder, the lead-frame defining at least three openings therein, wherein the three openings are in registration with three eyelets of the holder when the lead-frame is operatively connected to the holder; and at least three electrically conductive rivets each configured and adapted for at least partial positioning in a respective eyelet of the holder. Each rivet includes a stem portion and a head portion. A first opening and a second opening in the lead-frame are each larger than the head portion of a first and a second rivet such that the head portion of each first and second rivet does not contact the lead-frame. A third opening of the lead-frame is smaller than the head portion of a third rivet such that the head portion of the third rivet contacts the lead-frame.

The switch assembly further includes a pair of electrically conductive snap domes, wherein a first snap dome is in electrical contact with the lead-frame and overlies the first rivet, and wherein a second snap dome is in electrical contact with the lead-frame and overlies the second rivet. In use, depressing the first snap dome completes a first electrical circuit between the first rivet and the third rivet through the lead-frame and releasing the first snap dome disconnects the first electrical circuit. Additionally, in use, depressing the second snap dome completes a second electrical circuit between the second rivet and the third rivet through the lead-frame and releasing the second snap dome disconnects the second electrical circuit.

The holder may include a recess formed in an upper surface thereof. The recess is configured and dimensioned to receive at least the lead-frame, the rivets, and the snap domes therein. The switch assembly further includes an overmold configured and dimensioned to encase at least the holder, the lead-frame, the rivets, the snap domes, and the cover.

For a better understanding of the present invention and to show how it may be carried into effect, reference will be made by way of example to the accompanying drawings.

### BRIEF DESCRIPTION OF THE DRAWINGS

FIG. 1 is a perspective view, with parts separated, of a sealed soft switch assembly according to an embodiment of the present disclosure;

FIG. 2 is a bottom perspective view of the holder of the switch assembly of FIG. 1;

FIG. 3 is a bottom perspective view of the holder of FIG. 2 illustrating the connection of terminals thereto;

FIG. 4 is a side elevational view of the switch assembly of FIG. 1;

FIG. 5 is a top plan view of the switch assembly of FIG. 1;

FIG. 6 is a cross-sectional view of the switch assembly of FIGS. 1-5, as taken through 6-6 of FIG. 5;

FIG. 7 is a top plan view of the switch assembly of FIGS. 1-6, illustrating several components thereof in an assembled condition;

FIG. 8 is a perspective view of the switch assembly of FIGS. 1-7, shown with the overmold operatively associated therewith;

FIG. 9 is a side elevational view of the switch assembly of FIGS. 1-8;

FIG. 10 is a perspective view, with parts separated, of a sealed soft switch assembly according to another embodiment of the present disclosure;

FIG. 11 is a bottom perspective view of a holder of the switch assembly of FIG. 10, illustrating the connection of terminals thereto;

FIG. 12 is a side elevational view of the switch assembly of FIG. 10;

FIG. 13 is a top plan view of the switch assembly of FIG. 10;

FIG. 14 is a perspective view of the switch assembly of FIGS. 10, 12 and 13, shown with the overmold operatively associated therewith; and

FIG. 15 is a side elevational view of the switch assembly of FIG. 14.

### DETAILED DESCRIPTION OF EMBODIMENTS

Embodiments of the presently disclosed sealed soft switch assembly will now be described in detail with reference to the drawing figures wherein like reference numerals identify similar or identical elements. As used herein and as is traditional, the term “distal” refers to that portion which is furthest from the user while the term “proximal” refers to that portion which is closest to the user. In addition, terms such as “above”, “below”, “forward”, “rearward”, etc. refer to the orientation of the figures or the direction of components and are simply used for convenience of description.

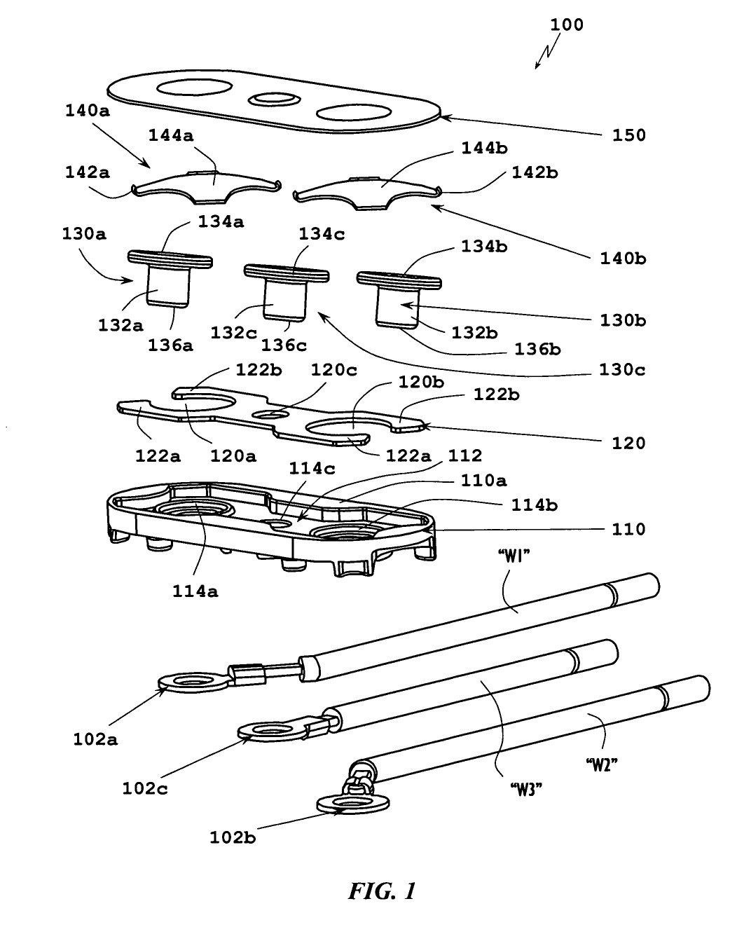

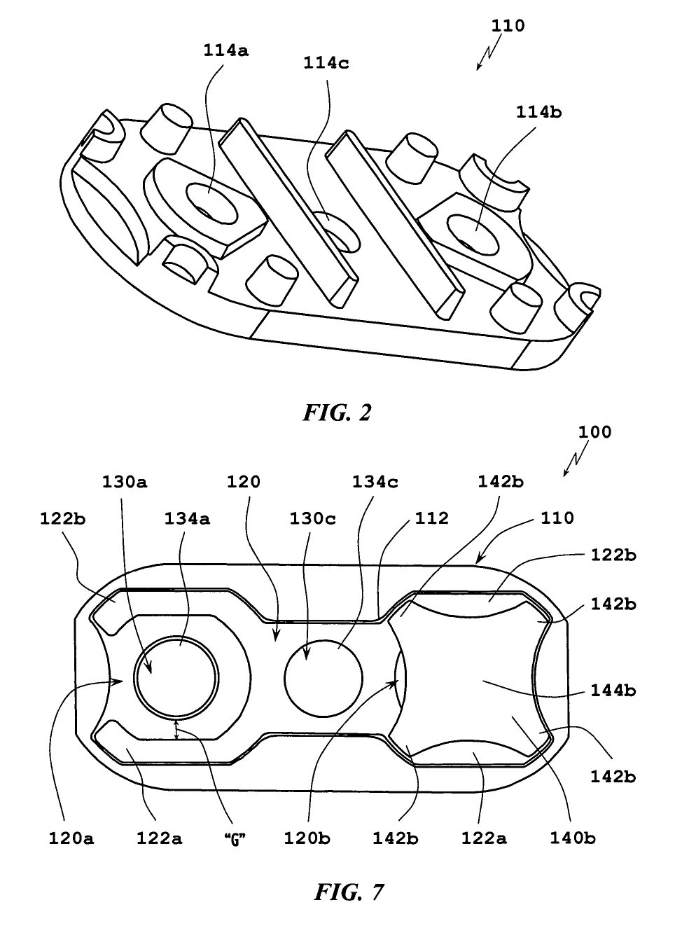

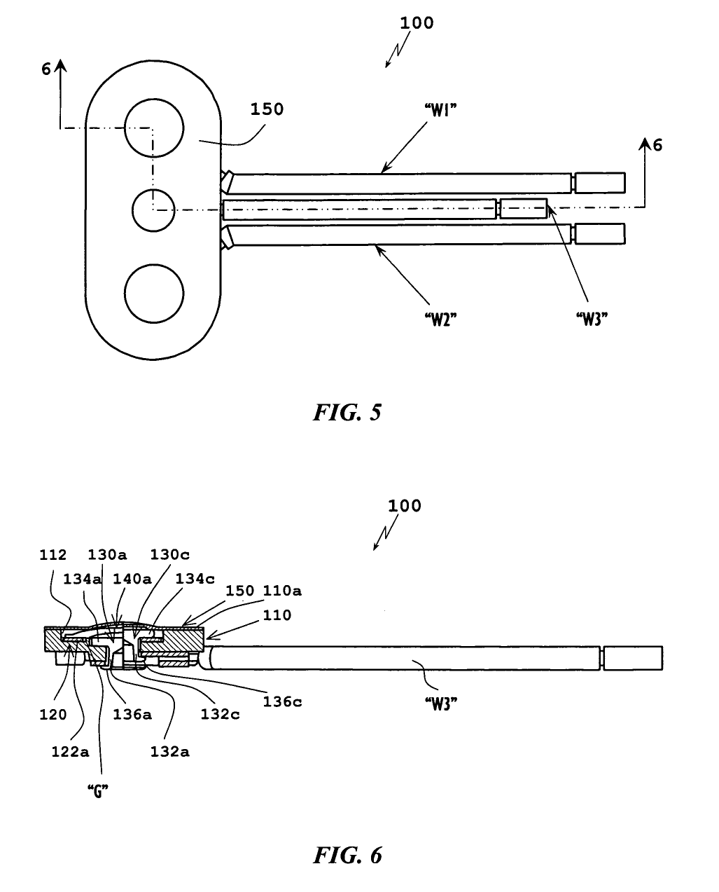

Referring initially to FIGS. 1-10, a sealed soft switch assembly in accordance with an embodiment of the present disclosure is generally designated as 100. Switch assembly 100 includes a holder 110 configured and adapted to operatively engage electrical terminals 102a, 102b and 102c of respective electrical wire leads “W1, W2 and W3”, a lead-frame 120 disposed within holder 110, rivets 130a-130c operatively disposed within holder 110, snap domes 140a, 140b operatively disposed within holder 110 and overlying a first and a third rivet 130a, 130b, respectively, and a cover 150 operatively disposed within holder 110 and overlying at least the snap domes 140a, 140b.

As seen in FIGS. 1-3, 6 and 7, holder 110 defines a recess 112 formed in an upper surface 110a thereof. Recess 112 is configured and dimensioned to receive lead-frame 120, rivets 130a-130c, and snap domes 140a, 140b therein. Holder 110 includes a plurality of eyelets 114a-114c formed in recess 112 and extending completely therethrough. Desirably, a first or right side eyelet 114a and a second or left side eyelet 114b are stepped, e.g., configured and dimensioned for insertion of stem portions 132a, 132b of respective rivets 130a, 130b and to enable respective head portions 134a and 134b of rivets 130a, 130b to be recessed therein. Meanwhile, central eyelet 114c is configured and dimensioned to solely receive stem portion 132c of rivet 130c.

Desirably, holder 110 is fabricated from an electrically insulative or non-conductive material.

As seen in FIGS. 1, 6 and 7, lead-frame 120 is substantially planar and is fabricated for electrically conductive material. Lead-frame 120 is configured and dimensioned for placement in recess 112 of holder 110. Lead-frame 120 includes a plurality of openings 120a-120c formed therein and/or defined thereby. Desirably, when lead-frame 120 is positioned within recess 112 of holder 110, each opening 120a-120c aligns with or registers with a respective eyelet 114a-114c of holder 110.

With continued reference to FIGS. 1, 6 and 7, lead-frame 120 includes a first or right side opening 120a, and a second or left side opening 120b. Each of right side and left side openings 120a, 120b, respectively, is defined by a pair of arms 122a, 122b. Each of right side and left side openings 120a, 120b, respectively, is configured and dimensioned to be larger than the size of head portions 134a, 134b of respective rivets 130a, 130b. In this manner, when lead-frame 120 and rivets 130a, 130b are disposed within holder 110, a space or gap “G” (see FIGS. 6 and 7) is defined around and between arms 122a, 122b and head portions 134a, 134b. Lead-frame 120 includes a third or central opening 120c configured and dimensioned to solely receive stem portion 132c of central rivet 130c. Accordingly, head portion 134c of central rivet 130c rests atop lead-frame 120.

As will be described in greater detail below, when snap domes 140a, 140b are placed in recess 112 of holder 110, snap domes 140a, 140b overlie and are in operative registration with a respective first and second rivet 130a, 130b, and rest upon or are in electrical contact with arms 122a, 122b of lead-frame 120.

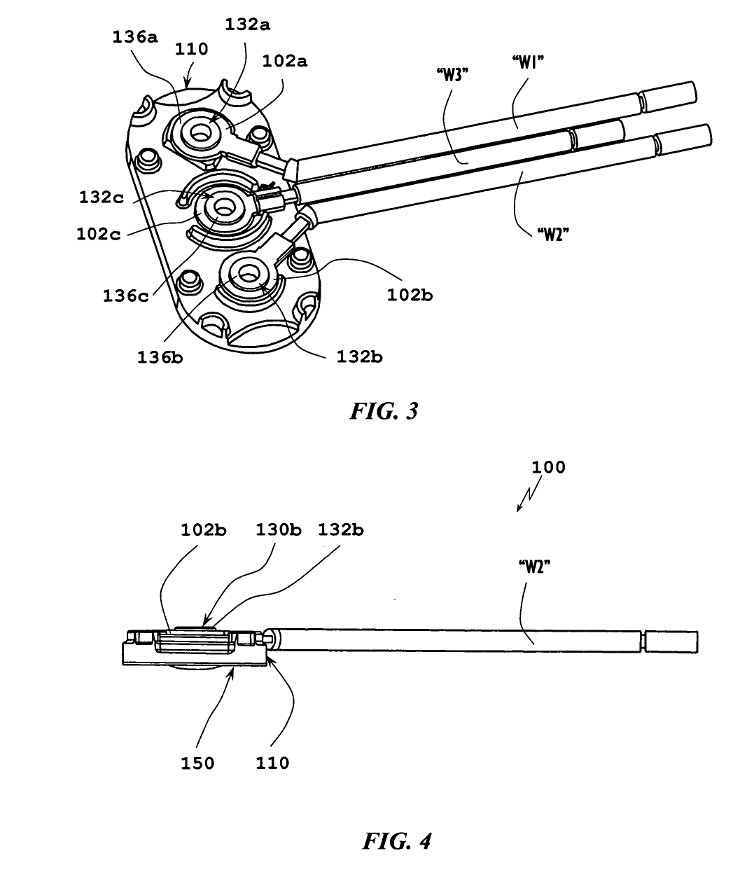

As seen in FIGS. 1, 3, 4 and 6, each rivet 130a-130c includes a respective stem portion 132a-132c, and a respective enlarged head portion 134a-134c. As mentioned above, stem portions 132a-132c of rivets 130a-130c are configured and adapted to extend through respective eyelets 114a-114c by an amount sufficient to electrically engage respective electrical terminals 102a-102c of electrical wire leads “W1-W3”, as seen in FIGS. 3 and 4. Rivets 130a-130c function to secure electrical terminals 102a-102c thereto and to create an electrical connection therewith. Desirably, each end 136a-136c of rivets 130a-130c is flared radially outward (see FIGS. 3 and 6) following passage of stem 132a-132c through electrical terminals 102a-102c. By crimping rivets 130a-130c in such a manner, the need to solder electrical terminals 102a-102c to a printed circuit board (not shown) is eliminated.

As seen in FIGS. 1, 6 and 7, each snap dome 140a, 140b includes contact pads or feet 142a, 142b, respectively, and a raised central region 144a, 144b, respectively. Each snap dome 140a, 140b is operatively disposed over a respective first and second rivet 130a, 130b when placed in recess 112 of holder 110. Each snap dome 140a, 140b is desirably fabricated from an electrically conductive material and configured so that when depressed, a predetermined range of motion is evident to the user (e.g., a tactile feedback) through a snap phase for closing the electrical circuit. The user develops a tactile “feel” through the range of motion and during activation of switch 100 when depressed.

In use, when snap dome 140a or 140b is depressed, the respective central region 144a, 144b of snap dome 140a or 140b contacts a respective rivet 130a, 130b and completes an electrical circuit between a respective first or second rivet 130a or 130b and lead-frame 120. In particular, if first snap dome 140a is depressed an electrical circuit or electrical current path is established between first wire lead “W1”, through first rivet 130a, through lead-frame 120, through third rivet 130c, to third wire lead “W3”. Similarly, if second snap dome 140b is depressed an electrical circuit or electrical current path is established between second wire lead “W2”, through second rivet 130b, through lead-frame 120, through third rivet 130c, to third wire lead “W3”.

As seen in FIGS. 1 and 4-6, a cover 150, fabricated from an electrically insulative or non-conductive pliable or flexible material may be provided to overlie snap domes 140a, 140b and protect the user from electrical shock during the use of switch 100 and to reduce the chances of snap domes 140a, 140b from becoming contaminated.

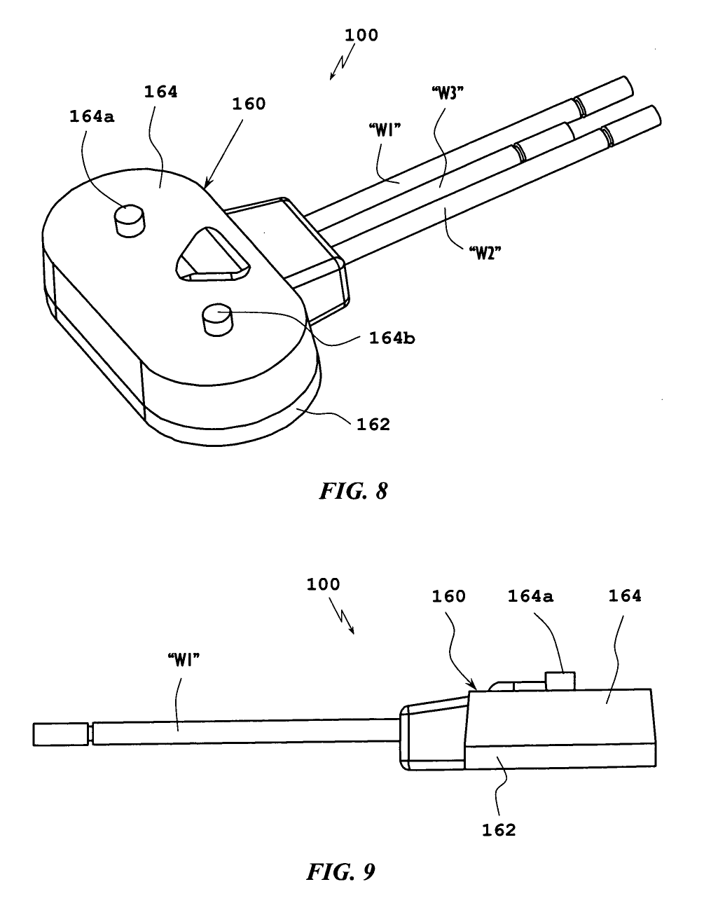

As seen in FIGS. 8 and 9, switch 100 may include an overmold 160 configured and adapted to surround, enclose and/or encase terminals 102a-102c, holder 110, lead-frame 120, rivets 130a-130c, snap domes 140a, 140b and cover 150. Desirably, overmold 160 is fabricated from a resilient, flexible polymeric material or the like. Overmold 160 includes a bottom half-section 162 and a top half-section 164. Top half-section 164 may include a pair of nubs 164a, 164b located substantially over respective snap domes 140a, 140b. In this manner, by pressing down on a nub 164a, 164b a respective snap dome 140a, 140b is depressed and/or actuated. Overmold 160 desirably forms a fluid tight enclosure for the contents therein.

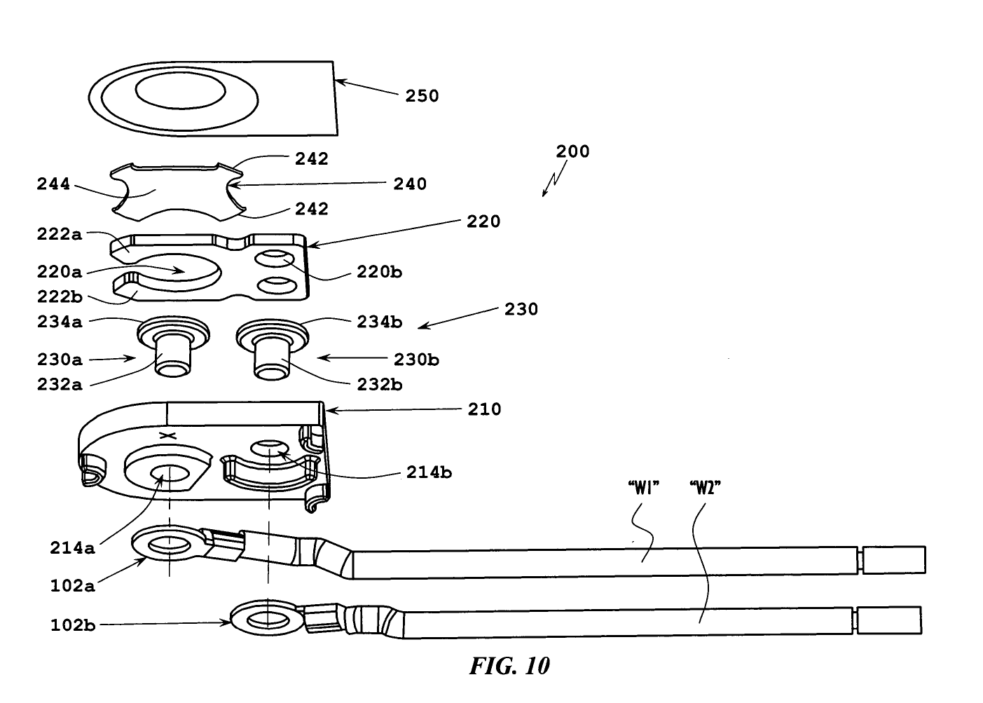

Turning now to FIGS. 10-15, a sealed soft switch assembly, in accordance with another embodiment of the present disclosure, is generally designated as 200. Switch assembly 200 is similar to switch assembly 100 and will only be discussed in detail to the extent necessary to identify differences in construction and operation.

Switch assembly 200 includes a holder 210 configured and adapted to operatively engage electrical terminals 102a, 102b of respective electrical wire leads “W1, W2”, a lead-frame 220 disposed within holder 210, rivets 230a, 230b operatively disposed within holder 210, a snap dome 240 operatively disposed within holder 210 and overlying a first rivet 230a, and a cover 250 operatively disposed within holder 210 and overlying at least snap dome 240 and rivets 230a, 230b.

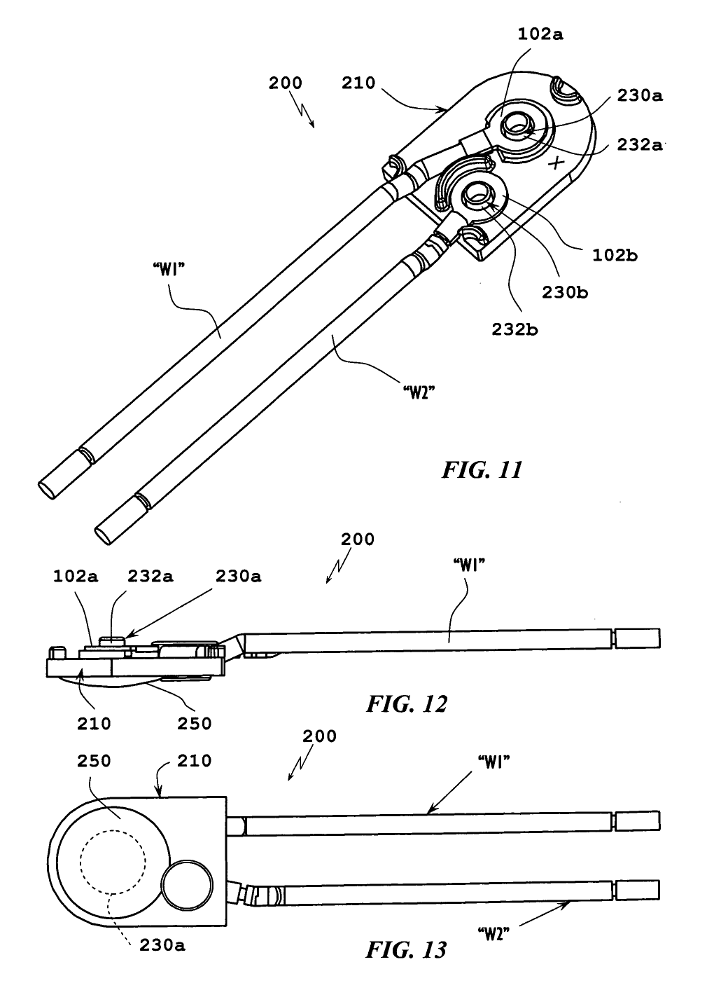

As seen in FIGS. 10 and 11, holder 210 includes a recess (not shown) formed in an upper surface thereof which is configured and dimensioned to receive lead-frame 220, rivets 230a, 230b, and snap dome 240 therein. Holder 210 includes a pair of eyelets 214a, 214b formed in the recess thereof and extending completely therethrough. Desirably, a first eyelet 214a is stepped, e.g., configured and dimensioned for insertion of stem portion 232a of rivet 230a and to enable head portion 234a of rivet 230a to be recessed therein. Meanwhile, second eyelet 214b is configured and dimensioned to solely receive stem portion 232b of rivet 230b.

As seen in FIG. 10, lead-frame 220 is substantially planar and is fabricated for electrically conductive material. Lead-frame 220 is configured and dimensioned for placement in the recess defined in holder 210. Lead-frame 220 includes at least a pair of openings 220a, 220b formed therein and/or defined thereby. Desirably, when lead-frame 220 is positioned within the recess of holder 210, openings 220a, 220b align with or register with a respective eyelet 214a, 214b of holder 210.

With continued reference to FIG. 10, lead-frame 220 includes a first opening 220a defined by a pair of arms 222a, 222b. First opening 220a is configured and dimensioned to be larger than the size of head portion 234a of rivet 230a. In this manner, when lead-frame 220 and rivet 230a is disposed within holder 210, a space or gap (similar to gap “G” shown in FIGS. 6 and 7) is defined around and between arms 222a, 222b and head portion 234a. Lead-frame 220 includes a second opening 220b configured and dimensioned to solely receive stem portion 232b of second rivet 230b. Accordingly, head portion 234b of second rivet 230b rests atop lead-frame 220.

As will be described in greater detail below, when snap dome 240 is placed in the recess of holder 210, snap dome 240 overlies and is in operative registration with a first rivet 230a, and rests upon or is in electrical contact with arms 222a, 222b of lead-frame 220.

As seen in FIG. 10, each rivet 230a, 230b includes a respective stem portion 232a, 232b, and a respective enlarged head portion 234a, 234b. As mentioned above, stem portions 232a, 232b of rivets 230a, 230b are configured and adapted to extend through respective eyelets 214a, 214b by an amount sufficient to electrically engage respective electrical terminals 202a, 202b of electrical wire leads “W1, W2”, as seen in FIGS. 11 and 12. Rivets 230a, 230b function to secure electrical terminals 202a, 202b thereto and to create an electrical connection therewith.

As seen in FIG. 10, snap dome 240 includes contact pads or feet 242, and a raised central region 244. Snap dome 240 is operatively disposed over first rivet 230a when placed in the recess of holder 210. In use, when snap dome 240 is depressed, the central region 244 of snap dome 240 contacts first rivet 230a and completes an electrical circuit between first rivet 230a and lead-frame 220. In particular, when snap dome 240 is depressed an electrical circuit or electrical current path is established between first wire lead “W1”, through first rivet 230a, through lead-frame 220, through second rivet 230b, to second wire lead “W2”.

As seen in FIGS. 10 and 12, a cover 250, fabricated from an electrically insulative or non-conductive pliable or flexible material may be provided to overlie snap dome 240 and protect the user from electrical shock during the use of switch 200 and to reduce the chances of snap dome 240 from becoming contaminated.

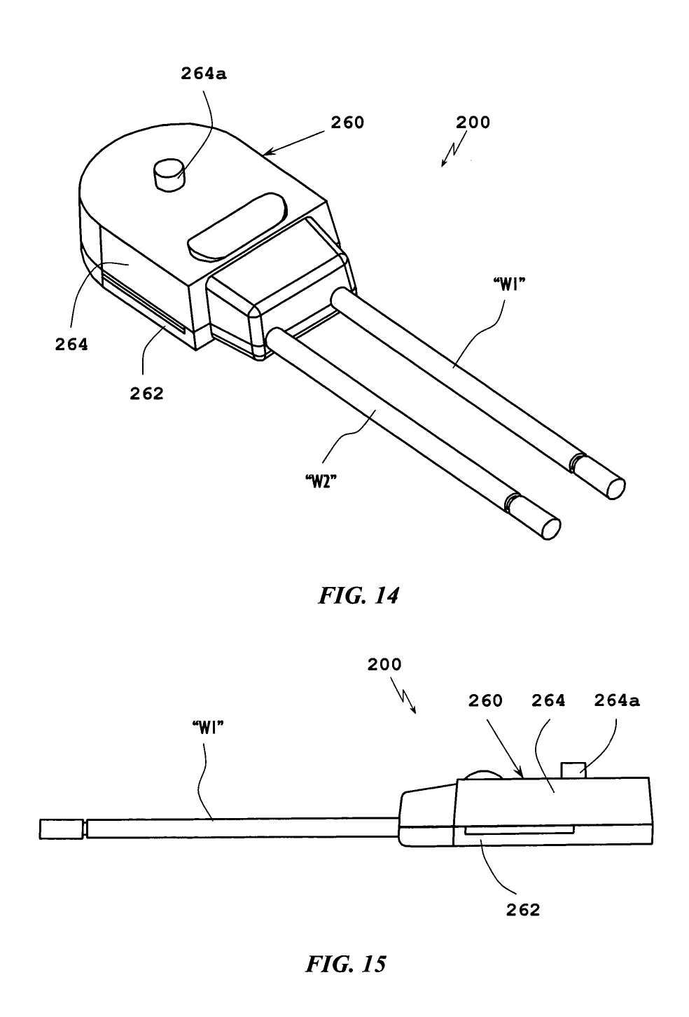

As seen in FIGS. 14 and 15, switch 200 may include an overmold 260 configured and adapted to surround, enclose and/or encase terminals 102a and 102b, holder 210, lead-frame 220, rivets 230a and 230b, snap dome 240, and cover 250. Desirably, overmold 260 is fabricated from a resilient, flexible polymeric material or the like. Overmold 260 includes a bottom half-section 262 and a top half-section 264. Top half-section 264 may include a nub 264a located substantially over snap dome 240. In this manner, by pressing down on nub 264a snap dome 240 is depressed and/or actuated. Overmold 260 desirably forms a fluid tight enclosure for the contents therein.

It is to be understood that the foregoing description is merely a disclosure of particular embodiments and is no way intended to limit the scope of the invention. Other possible modifications will be apparent to those skilled in the art and all modifications will be apparent to those in the art and all modifications are to be defined by the following claims.

What is claimed is:

1. A switch assembly, comprising:
a holder defining at least a pair of eyelets extending completely therethrough;
an electrically conductive lead-frame supported on the holder, the lead-frame defining at least a pair of openings therein, each opening being aligned with a respective eyelet formed in the holder;
at least a pair of electrically conductive rivets each configured and adapted for at least partial positioning in a respective eyelet, each rivet including a stem portion and a head portion;
wherein a first opening of at least the pair of openings of the lead-frame is larger than the head portion of a first rivet such that the head portion of the first rivet does not contact the lead-frame, and a second opening of at least the pair of openings of the lead-frame is smaller than the head portion of another rivet such that the head portion of the other rivet contacts the lead-frame; and
at least one electrically conductive snap dome in electrical contact with the lead-frame and overlying the first rivet;
wherein depressing the snap dome completes an electrical circuit between the first rivet and the second rivet through the lead-frame, and releasing the snap dome disconnects the electrical circuit.

2. The switch assembly according to claim 1, further comprising a flexible non-conductive cover configured and dimensioned to overlie at least the first snap dome.

3. The switch assembly according to claim 2, further comprising an overmold configured and dimensioned to encase at least the holder, the lead-frame, the rivets, the snap dome, and the cover.

4. The switch assembly according to claim 3, wherein at least one nub is provided on the overmold substantially over the snap dome.

5. The switch assembly according to claim 3, wherein an electrical wire is connectable to each of the rivets.

6. The switch assembly according to claim 1, wherein the holder includes a recess formed in an upper surface thereof, the recess being configured and dimensioned to receive at least the lead-frame, the rivets and the snap dome therein.

7. The switch assembly according to claim 1, wherein the holder defines at least three eyelets formed therein and extending completely therethrough.

8. The switch assembly according to claim 7, wherein the lead-frame defines at least three openings therein, wherein the three openings are in registration with the three eyelets of the holder when the lead-frame is operatively connected to the holder.

9. The switch assembly according to claim 8, wherein the first and the second openings of the lead-frame are each larger than a third opening of the lead-frame.

10. The switch assembly according to claim 9, further comprising at least three electrically conductive rivets each configured and adapted for at least partial positioning in a respective eyelet of the holder, each rivet including a stem portion and a head portion.

11. The switch assembly according to claim 10, wherein a third opening of the lead-frame is smaller than the head portion of a third rivet such that the head portion of the third rivet contacts the lead-frame.

12. The switch assembly according to claim 11, further comprising a pair of snap domes, wherein a first snap dome is in electrical contact with the lead-frame and overlies the first rivet, and wherein a second snap dome is in electrical contact with the lead-frame and overlies the second rivet.

13. The switch assembly according to claim 12, wherein depressing the first snap dome completes a first electrical circuit between the first rivet and the third rivet through the lead-frame and releasing the first snap dome disconnects the first electrical circuit; and wherein depressing the second snap dome completes a second electrical circuit between the second rivet and the third rivet through the lead-frame and releasing the second snap dome disconnects the second electrical circuit.

14. The switch assembly according to claim 13, further comprising a flexible non-conductive cover configured and dimensioned to overlie at least the first and second snap domes.

15. The switch assembly according to claim 14, further comprising an overmold configured and dimensioned to encase at least the holder, the lead-frame, the rivets, the snap domes, and the cover.

16. The switch assembly according to claim 15, wherein an electrical wire is connected to each rivet.

17. The switch assembly according to claim 16, wherein the holder includes a recess formed in an upper surface thereof, the recess being configured and dimensioned to receive at least the lead-frame, the rivets, and the snap domes therein.

18. A switch assembly connectable to electrical terminals of electrical wire leads, the switch assembly comprising:
a holder defining at least three eyelets formed therein and extending completely therethrough;
an electrically conductive lead-frame supported on the holder, the lead-frame defining at least three openings therein, wherein the three openings are in registration with three eyelets of the holder when the lead-frame is operatively connected to the holder;
at least three electrically conductive rivets each configured and adapted for at least partial positioning in a respective eyelet of the holder, each rivet including a stem portion and a head portion;
wherein a first opening and a second opening in the lead-frame are each larger than the head portion of a first and a second rivet such that the head portion of each first and second rivet does not contact the lead-frame, and a third opening of the lead-frame is smaller than the head portion of a third rivet such that the head portion of the third rivet contacts the lead-frame; and
a pair of electrically conductive snap domes, wherein a first snap dome is in electrical contact with the lead-frame and overlies the first rivet, and wherein a second snap dome is in electrical contact with the lead-frame and overlies the second rivet;
wherein depressing the first snap dome completes a first electrical circuit between the first rivet and the third rivet through the lead-frame and releasing the first snap dome disconnects the first electrical circuit; and wherein depressing the second snap dome completes a second electrical circuit between the second rivet and the third rivet through the lead-frame and releasing the second snap dome disconnects the second electrical circuit.

19. The switch assembly according to claim 18, wherein the holder includes a recess formed in an upper surface thereof, the recess being configured and dimensioned to receive at least the lead-frame, the rivets, and the snap domes therein.

20. The switch assembly according to claim 19, further comprising an overmold configured and dimensioned to encase at least the holder, the lead-frame, the rivets, the snap domes, and the cover.
